(19) United States
(12) Patent Application Publication
(10) Pub. No.: US 2017/0120969 A1
(43) Pub. Date: May 4, 2017

(54) BELLY PAN WITH AERO COVERS

(71) Applicant: FORD GLOBAL TECHNOLOGIES, LLC, Dearborn, MI (US)

(72) Inventor: Santiago Bonilla Veliz, Mexico City (MX)

(21) Appl. No.: 14/932,354

(22) Filed: Nov. 4, 2015

(51) Int. Cl. B62D 35/02

(52) U.S. Cl. CPC B62D 35/02

(57) ABSTRACT

A belly pan is provided for a motor vehicle. That belly pan includes a body panel having a first corner buttress, a second corner buttress, a first open rib structure reinforcing the first corner buttress and a second open rib structure reinforcing the second corner buttress. The belly pan also includes a first aero cover spanning and closing the first open rib structure and a second aero cover spanning and closing the second open rib structure.

### TECHNICAL FIELD

This document relates generally to the motor vehicle equipment field and, more particularly, to a belly pan for a motor vehicle incorporating forward corner buttresses with a unique open rib structure for extra rigidity and aero covers for improved aerodynamic performance.

### BACKGROUND

It is well known in the art to equip a motor vehicle with a belly pan in order to improve airflow and increase the fuel economy of a motor vehicle. In a typical application the belly pan extends between the front fascia of the motor vehicle and a lower radiator support.

This document relates to a new and improved belly pan that incorporates front corner buttresses having an open rib structure for added rigidity to improve pedestrian safety in the event of a lower leg impact. Further, the belly pan also includes aero covers that span the open rib structures to maintain the desired aerodynamic performance that enhances the fuel economy of the motor vehicle. Accordingly, it should be appreciated that the belly pan described herein represents a significant advance in the art.

### SUMMARY

In accordance with the purposes and benefits described herein, a belly pan is provided for a motor vehicle. That belly pan comprises a body panel having a forward section constructed from an open rib structure and an aero cover carried on the body panel and spanning the open rib structure.

In one possible embodiment, the body panel includes a first forward corner and a second forward corner. The first forward corner includes a first section of open rib structure and the second forward corner includes a second section of open rib structure.

A first aero cover spans and closes the first section of open rib structure while a second aero cover spans and closes the second section of the rib structure.

The first section of open rib structure includes a first fore-aft rib and a first plurality of transverse ribs projecting from opposed sides of the first fore-aft rib. Similarly, the second section open rib structure includes a second fore-aft rib and a second plurality of transverse ribs projecting from opposed sides of the second fore-aft rib.

Still further, the body panel includes a plurality of closed ribs. The first section of open rib structure is provided between a first two ribs of the plurality of closed ribs. The second section of open rib structure is provided between a second two ribs of the plurality of closed ribs. Fasteners secure the first aero cover and the second aero cover to the body panel.

In one particularly useful embodiment, the body panel includes a first corner buttress and a second corner buttress.

The first section of open rib structure forms a part of and reinforces the first buttress and the second section of open rib structure forms a part of and reinforces the second buttress.

In one possible embodiment, the body panel is made from a material having a tensile and flexural modulus of at least 7.8 GPa. In one possible embodiment, the body panel is molded from polypropylene reinforced with 40% long glass fibers. Further, the body panel has a thickness of about 3.5 mm. In contrast, the first and second aero covers have a thickness of about 2.5 mm.

In accordance with yet another aspect, a belly pan for a motor vehicle comprises a body panel having a first corner buttress, a second corner buttress, a first open rib structure reinforcing the first corner buttress and a second open rib structure reinforcing the second corner buttress. In addition, the belly pan includes a first aero cover spanning and closing the first open rib structure and a second aero cover spanning and closing the second open rib structure.

In one possible embodiment the body panel includes a first section and a second section secured together by fasteners. The first corner buttress is provided on the first section while the second corner buttress is provided on the second section.

The first open rib structure includes a first fore-aft rib and a first plurality of transverse ribs projecting from opposed sides of the first fore-aft rib. Similarly, the second open rib structure includes a second fore-aft rib and a second plurality of transverse ribs projecting from opposed sides of the second fore-aft rib. Further, the body panel includes a plurality of closed ribs. The first section of open rib structure is provided between a first two ribs of the plurality of closed ribs while the second section of open rib structure is provided between a second two ribs of the plurality of closed ribs.

In the following description, there are shown and described several preferred embodiments of the belly pan. As it should be realized, the belly pan is capable of other, different embodiments and its several details are capable of modification in various, obvious aspects all without departing from the belly pan as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the belly pan and together with the description serve to explain certain principles thereof. In the drawing figures:

FIG. 1 is an exploded perspective view of the belly pan that is the subject matter of this document.

FIG. 2a is a detailed perspective view illustrating one aero cover secured on the body panel of the belly pan.

FIG. 2b is a detailed view of one of the open rib structures clearly illustrating the fore-aft rib and the plurality of transverse ribs extending between the fore-aft rib and the two adjacent closed ribs of the body panel.

FIGS. 3 and 4 are respective bottom perspective and top perspective views of the fully assembled belly pan.

FIG. 5 is a perspective view from below illustrating the mounting of the belly pan on a motor vehicle between the front fascia and the lower radiator support.

FIG. 6 is a perspective side view illustrating the fully assembled belly pan on the motor vehicle extending between the front fascia and the lower radiator support.

Reference will now be made in detail to the present preferred embodiments of the belly pan, examples of which are illustrated in the accompanying drawing figures.

### DETAILED DESCRIPTION

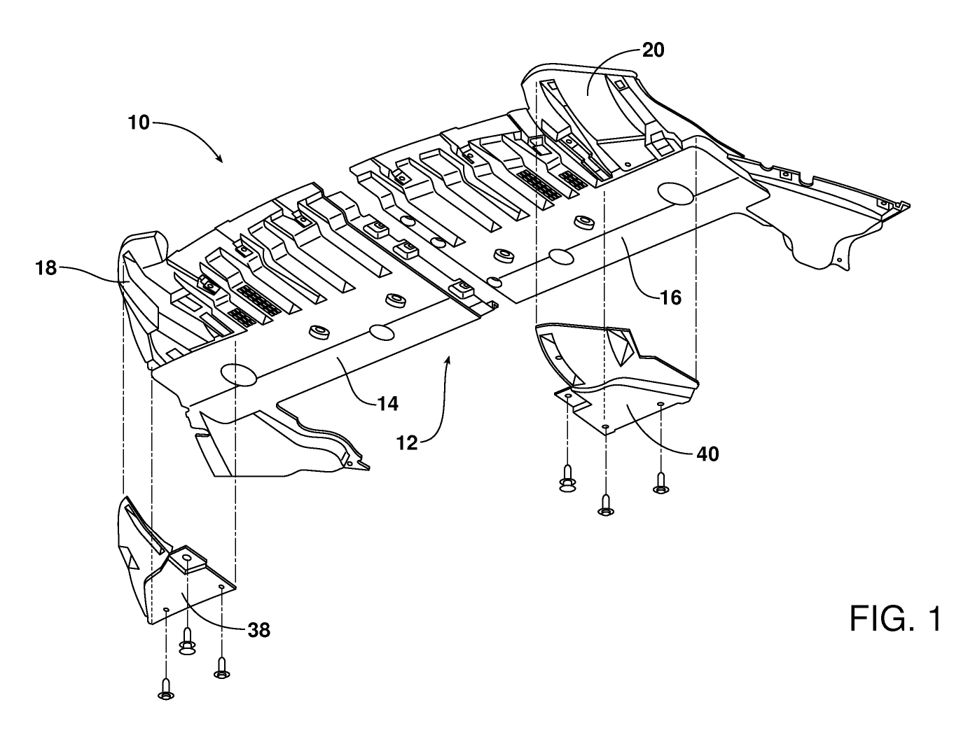

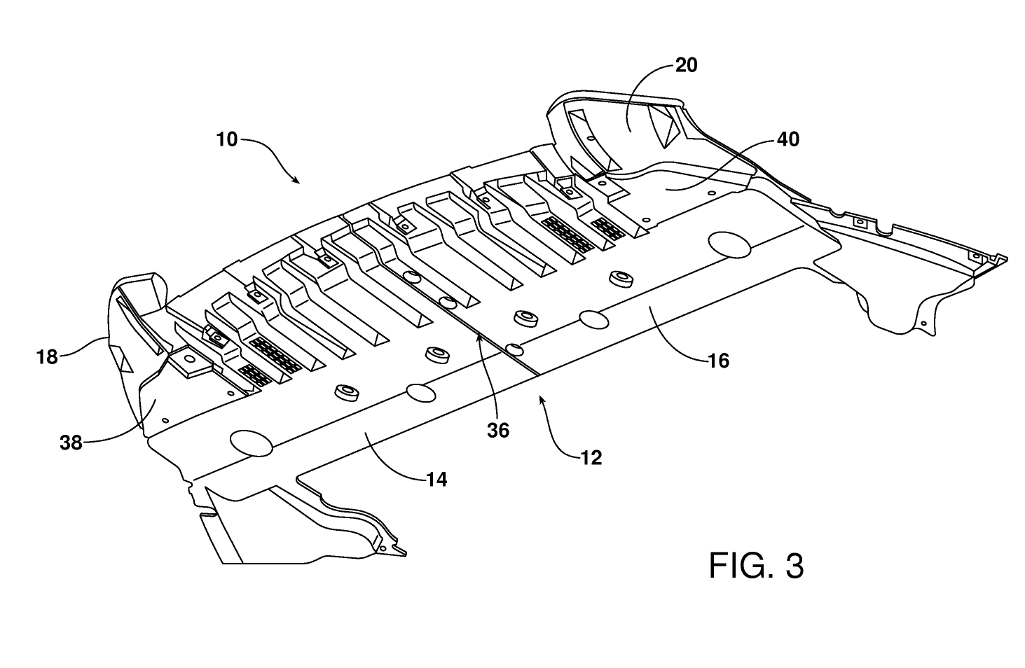

Reference is now made to FIGS. 1-4 illustrating the belly pan 10 that is the subject matter of this document. As illustrated, the belly pan 10 includes a body panel 12 that may be formed in two sections, a first or left hand section 14 and a second or right hand section 16.

As illustrated, the first section 14 includes a first corner buttress 18. Similarly, the second section 16 includes a second corner buttress 20. As illustrated, the two corner buttresses 18, 20 are provided at the vehicle forward corners of the belly pan 10.

A first open rib structure 22 reinforces the first corner buttress 18. Similarly, a second open rib structure 24 reinforces the second corner buttress 20.

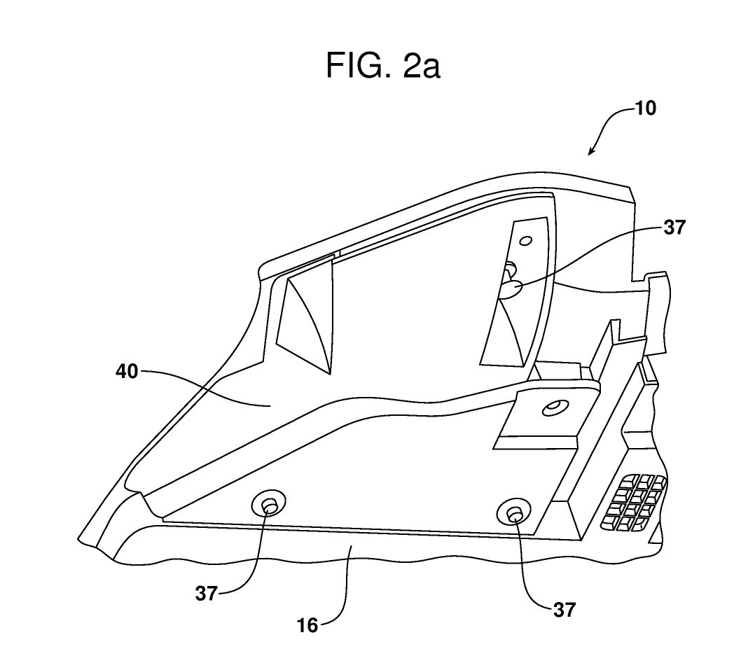

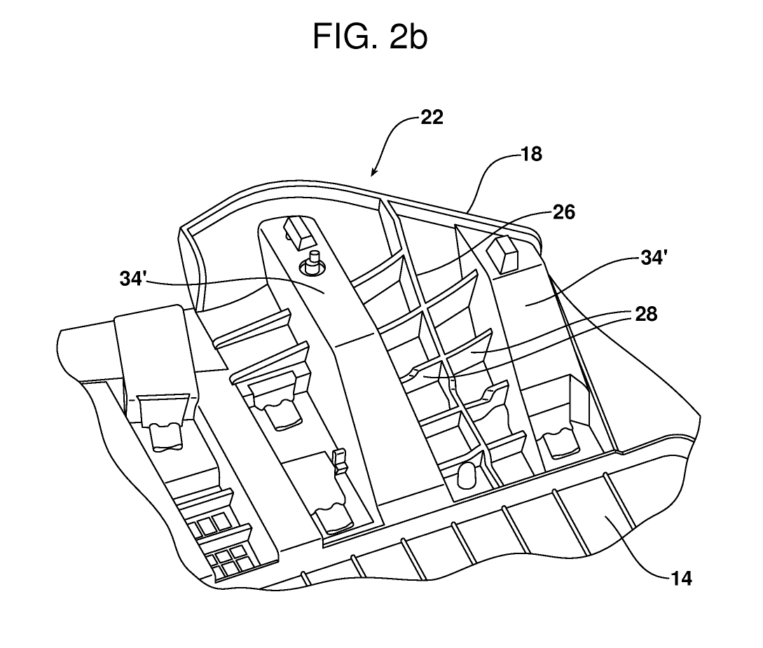

As best illustrated in FIG. 2b, the first open rib structure 22 includes a first fore-aft rib 26 and a first plurality of laterally extending or transverse ribs 28 projecting from opposed sides of the first fore-aft rib.

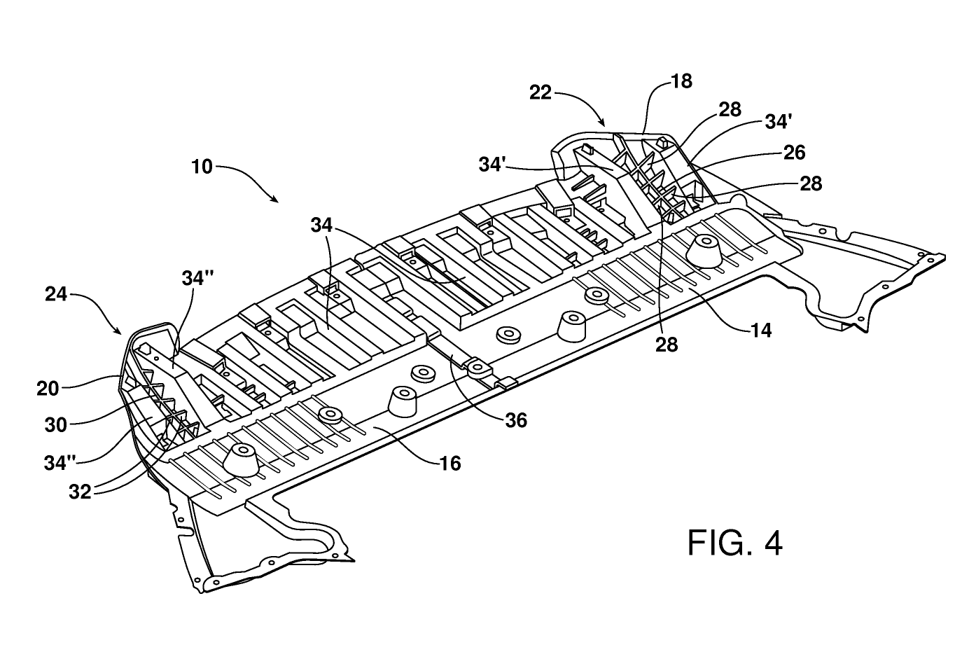

Similarly, the second section of open rib structure 24 includes a second fore-aft rib 30 and a second plurality of laterally extending or transverse ribs 32 projecting from opposed sides of the second fore-aft rib. See FIG. 4.

In FIGS. 1-4, the body panel 12 also includes a plurality of closed ribs or corrugations 34. These ribs 34 extend in a fore-aft direction across the entire width of the body panel 12 from the joining center margins 36 of the two body panel sections 14, 16 to the two corner buttresses 18, 20.

As further illustrated, the two outermost or end ribs 34′ of the first section 14 are raised to form a part of the first corner buttress 18. The first plurality of transverse ribs 28 extend between the first fore-aft rib 26 and the two raised corner ribs 34′.

Similarly, the two outermost ribs 34″ on the second body panel section 16 are also raised to form a part of the second corner buttress 20. The second plurality of transverse ribs 32 extending from the second fore-aft rib 30 extend between the fore-aft rib 30 and these two corner ribs 34″.

As further illustrated in FIGS. 1-4, the belly pan 10 also includes a first aero cover 38 and a second aero cover 40. The first aero cover 38 spans and closes the first section of open rib structure 22 while the second aero cover 40 spans and closes the second section of open rib structure 24.

In one possible embodiment the body panel 12 is made from a material having a tensile and flexural modulus of at least 7.8 GPA. In one possible embodiment, the body panel 12 is molded from polypropylene reinforced with 40% long glass fibers. The body panel 12 may have a thickness of about 3.5 mm while the aero covers 38 and 40 may have a thickness of about 2.5 mm.

The belly pan 10 is assembled by aligning the center edges/margins 36 of the two belly panel sections 14, 16 and securing together with appropriate fasteners 37 such as pushpins, screws and/or nuts and bolts. The first aero cover 38 and the second aero cover 40 are then secured to the ribs or corrugations 34′ and 34″ of the respective first and second corner buttresses 18, 20 by appropriate fasteners such as resilient clips, locators, pushpins, screws, nuts and other appropriate fasteners and combinations thereof.

In the illustrated embodiment, the body panel 12 includes two sections 14, 16. These two sections can aid in the installation of the belly pan 12 onto the motor vehicle. As should be appreciated, however, the body panel 12 may be formed from a single continuous piece rather than the two illustrated sections.

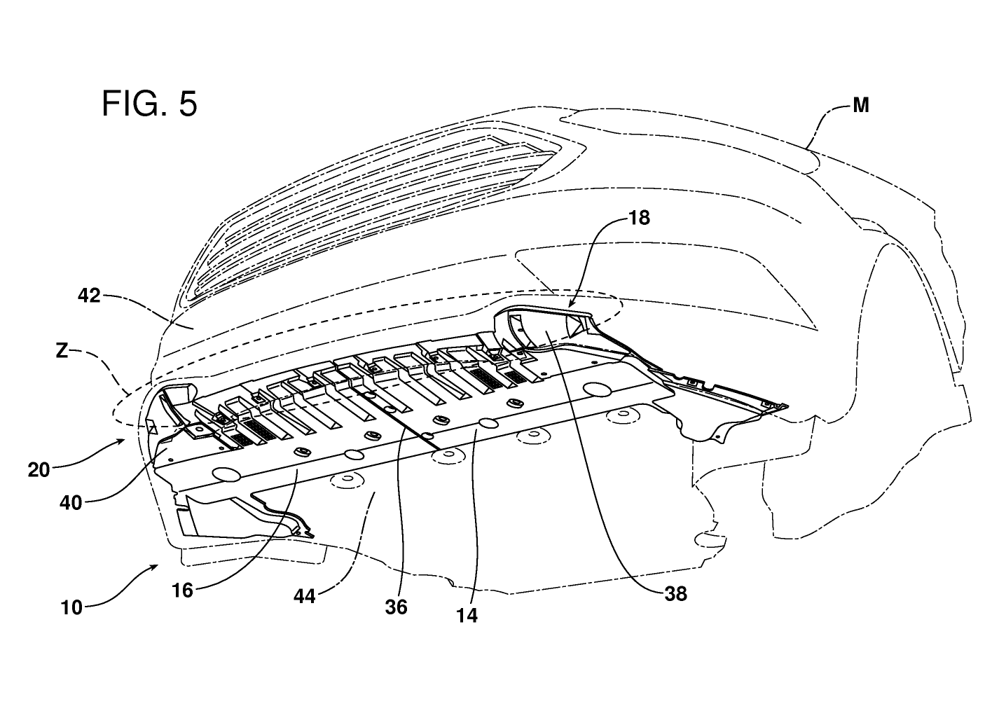

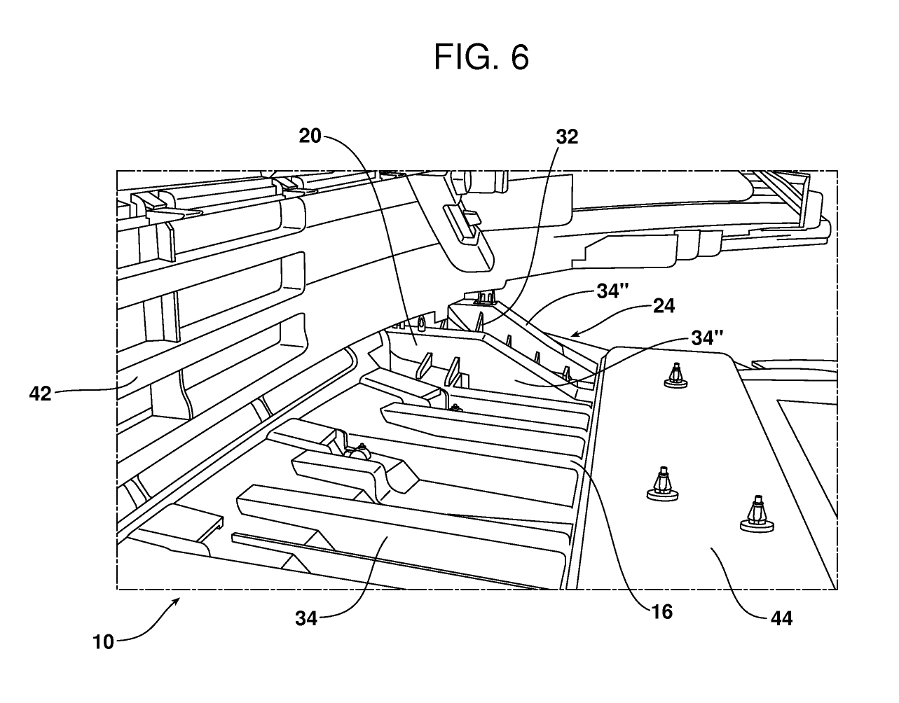

Reference is now made to FIGS. 5 and 6 illustrating the belly pan 10 in its installed position within the motor vehicle M. In this position, the belly pan 10 extends between the grille/front fascia 42 and the lower radiator support 44. As illustrated, the ribs or corrugations 34, 34′, 34″ have a “piano key geometry.” The first and second corner buttresses 18, 20 at the forward corners of the body panel 12 incorporate the first and second open rib structures 22, 24 that provide additional rigidity and improve the safety performance of the belly panel 10 in the event of a pedestrian impact anywhere along the lower leg impact zone Z. At the same time, the aero covers 38 and 40 are provided along the bottom face of the body panel 12 covering and spanning the first and second open rib structures 22, 24 so as to maintain the enhanced aerodynamics necessary to improve airflow and the overall fuel economy of the motor vehicle.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

1. A belly pan for a motor vehicle, comprising:
a body panel having a first forward corner including a first section of open rib structure and a second forward corner including a second section of open rib structure;
a first aero cover carried on said body panel and spanning and closing said first section of open rib structure; and
a second aero cover carried on said body panel and spanning and closing said second section of open rib structure.

2. (canceled)

3. (canceled)

4. (canceled)

5. The belly pan of claim 1, wherein said first section of open rib structure includes a first fore-aft rib and a first plurality of transverse ribs projecting from opposed sides of said first fore-aft rib.

6. The belly pan of claim 5, wherein said second section of open rib structure includes a second fore-aft rib and a second plurality of transverse ribs projecting from opposed sides of said second fore-aft rib.

7. The belly pan of claim 6, wherein said body panel includes a plurality of closed ribs, said first section of open rib structure being provided between a first two ribs of said plurality of closed ribs and said second section of open rib structure being provided between a second two ribs of said plurality of closed ribs.

8. The belly pan of claim 7, including fasteners securing said first aero cover and said second aero cover to said body panel.

9. The belly pan of claim 8, wherein said body panel includes a first corner buttress and a second corner buttress.

10. The belly pan of claim 9, wherein said first section of open rib structure forms a part of said first buttress and said second section of open rib structure forms a part of said second buttress.

11. The belly pan of claim 10, wherein said body panel is made from a material having a tensile and flexural modulus of at least 7.8 GPa.

12. The belly pan of claim 11, wherein said body panel is molded from polypropylene reinforced with 40% long glass fibers.

13. The belly pan of claim 12, wherein said body panel has a thickness of about 3.5 mm.

14. The belly pan of claim 13, wherein said first aero cover and said second aero cover have a thickness of about 2.5 mm.

15. A belly pan for a motor vehicle, comprising:
a body panel having a first corner buttress, a second corner buttress, a first open rib structure reinforcing said first corner buttress and a second open rib structure reinforcing said second corner buttress;
a first aero cover spanning and closing said first open rib structure; and
a second aero cover spanning and closing said second open rib structure.

16. The belly pan of claim 15, wherein said body panel includes a first section and a second section secured together by fasteners.

17. The belly pan of claim 16, wherein said first corner buttress is on said first section and said second corner buttress is on said second section.

18. The belly pan of claim 17, wherein said first open rib structure includes a first fore-aft rib and a first plurality of transverse ribs projecting from opposed sides of said first fore-aft rib.

19. The belly pan of claim 18, wherein said second open rib structure includes a second fore-aft rib and a second plurality of transverse ribs projecting from opposed sides of said second fore-aft rib.

20. The belly pan of claim 19, wherein said body panel includes a plurality of closed ribs, said first section of open rib structure being provided between a first two ribs of said plurality of closed ribs and said second section of open rib structure being provided between a second two ribs of said plurality of closed ribs.
